(19) United States
(12) Patent Application Publication
(10) Pub. No.: US 2023/0311037 A1
(43) Pub. Date: Oct. 5, 2023

(54) HIGH FILTRATION FILTER WITH DISINFECTION, LOW PRESSURE DROP AND REDUCED CAKE FORMATION

(71) Applicant: THE HONG KONG POLYTECHNIC UNIVERSITY, Hong Kong (CN)

(72) Inventor: Wallace Woon Fong LEUNG, Hong Kong (CN)

(21) Appl. No.: 18/005,682

(22) PCT Filed: Jul. 17, 2020
(86) PCT No.: PCT/CN2020/102725

§ 371 Date: Jan. 17, 2023

(51) Int. Cl. B01D 39/16

(52) U.S. Cl. CPC B01D 39/1623; A62B 23/025; B01D 2239/025; B01D 2239/0258; B01D 2239/0435; B01D 2239/0442; B01D 2239/0631; B01D 2239/0654; B01D 2239/1233; B01D 2239/1291

(57) ABSTRACT

A high filtration filter for filtering aerosols with low pressure drop across the filter and reduced cake formation when the aerosols penetrate through from an upstream side to a downstream side is disclosed. The filter (100) includes a plurality of module layers (110) and a plurality of separators (120). An individual module layer is an electrostatically-charged polyvinylidene fluoride (PVDF) nanofiber mat. The electrostatically-charged PVDF nanofiber mat with charged nanofibers is configured to better capture aerosols. The plurality of module layers and the plurality of separators are alternatingly stacked and connected to one another. Each of the individual module layers has an appropriate fiber basis weight, thereby the aerosols are captured by the charged nanofibers and distributed uniformly across an entire width of the filter from the upstream side (41) to the downstream side (42). The fiber basis weight of nanofibers is selected to minimize the formation of skin leading to formation of a cake layer on the upstream side of the filter module. The filter also carries antimicrobials to disinfect bacteria, viruses, and harmful microbials carried by the trapped aerosols in the filter.

### FIELD OF THE INVENTION

The present disclosure generally relates to a high filtration filter. In particular, the present disclosure relates to a high filtration filter with effective disinfection and low pressure drop across the filter, which can significantly reduce or limit the cake formation.

### BACKGROUND OF THE INVENTION

Since the worldwide outbreak of the coronavirus disease 2019 (COVID-19), demand for personal protection against the airborne virus, such as face masks and respirators, has remained high. Not only for the healthcare workers, some countries recommend or mandate the use of face mask in public, such as on public transport, in confined or crowded environments, to stop the spread of the virus during the COVID-19 pandemic or peak season for influenza.

The size of the COVID-19 virus is 60-140 nm in size with nano-spikes coated on its spherical viral capsid or envelop with spike heights of 9-12 nm. COVID-19 belongs to the coronavirus family for which their family members, SARS and MERS, also pose a serious global health threat in recent years. SARS virus has a size of 70-92 nm, with the virus capsid wrapped by at least 15 spikes. MERS virus has a spherical shape with a size of 118-136 nm and has 16-21 nm spikes on its surface. The other influenza virus has a majority size of about 120 nm and also has spikes. In particular, one of the influenzas, Influenza A, has a size of 100 nm.

All these viruses can be aerosolized as they can be attached to fine aerosols (solid particle or droplet) from an infected person or resuspended after attaching to surfaces (floor, wall, and used facemask and personal protective clothing, etc.). The coronavirus is better equipped with prominent spikes for better anchorage to their carriers during transport as well as their host cells. Once airborne, there is a possibility that they can be transferred to ambient aerosols during their flight. The smaller the aerosol, the longer that the virus-carrying aerosol is suspended in the air or airborne, thereby the longer distance for which the virus can spread. The aerosol can be a solid particulate or a respiratory droplet. It has been known that breathing, talking, singing, coughing and sneezing may also generate a lot of aerosols under 10 µm. COVID-19 virus can be attached to the respiratory droplets of the infected person, and during free flight and under low relative humidity the respiratory droplet can be reduced down to ⅒ of its original size or droplet nuclei (without liquid) due to evaporation. Therefore, the aerosol may be well into the submicron size (≤1 µm) or even nanoaerosol size (≤0.1 µm). Further, the aerosols carrying virus attached to surfaces (walls, floors, coats, used personal protective equipment (PPE) such as facemask, respirators and protective clothing) can be resuspended in air once they are agitated. For example, aerosols of size 0.01 to 1 µm carrying COVID-19 RNA was found in one hospital PPE changing rooms for the medical staff and also medical staff station in February to March 2020. In particular, a high dose of submicron aerosols of 0.25-1 µm carrying COVID-19 RNA was found in the two PPE changing rooms. These are all attributed to resuspension of aerosols due to activities in these area. Similar cases can be found in common facilities used during community outbreak such as elevators, public transport, etc. This is especailly when the area is not ventilated well and is congested with people. The resuspension of tiny aerosols carrying COVID-19 coupled with the findings that COVID-19 is quite stable for up to 2-7 days on untreated (without disinfected) surfaces (steel, surface of used face mask, etc.) under room temperature.

For the COVID-19 virus, the minimum size is about 60 nm. As shown in FIG. 1A, when the virus is attached to a smaller carrier aerosol, the combined size is still about 60 nm, or larger. Similarly shown in FIG. 1B, when the virus is attached to a larger carrier aerosol, the combined size may be 100 nm or larger. The effectiveness of a filter greatly depends on the ability to limit the aerosol from passing through the filter.

In filtering aerosols from the air, the clean filter first captured aerosols in the filter, which is known as “depth filtration”. For air that contains a large fraction of submicron aerosols, the capturing mechanism is by means of diffusion. When the small aerosol making random motion departs from the streamline of the flow due to its small size and especially at elevated temperature, the small aerosol may strike the randomly oriented nanofibers of the filter and get captured at either the windward or leeward side of the fiber. Diffusion capture pertains to aerosols with a size of less than roughly 200 nm. The smaller is the aerosol, the greater is the diffusion mechanism, as small size aerosol can have a high degree of random motion.

Another important aerosol capture mechanism is interception, where aerosols are brought to the fibers in the filter by the streamline of the flow and get captured. Typically, the aerosol got captured on the windward side of the fiber. This mechanism works well for aerosols greater than roughly 200 nm. The larger is the aerosol, the more prominent is the interception effect.

A third aerosol capture mechanism is electrostatic, which works for aerosols and/or fibers that have electrostatic charges. As a neutrally charged aerosol get close to a charged fiber, an electric dipole moment is induced on the aerosol. The charge of the dipole interacting with the oppositely charged fiber results in the aerosol capture. This mechanism works well for aerosols greater than 100 nm. The larger is the aerosol size, and the greater is the electrostatic capture. This is because the distance between the induced positive and negative charges is much further apart, which reduces the chance of the induced charges in recombining together. Also, the dipole moment, which is the induced charge multiplied by the distance separation of the induced charges, is much larger. Therefore, the large dipole moment induced for the larger aerosols facilitates stronger electrostatic capture. All three mechanisms work together to enhance the filtration of submicron aerosols.

Non-woven materials have been a reliable material for producing synthetic fibers with different diameters and morphology for air filtration. Microfibers from the melt-blown process can generate microfibers with a diameter of 1 µm to 20 µm. They are commonly used as non-woven filter media. Alternatively, nanofibers with a diameter of 100 nm to 600 nm, produced from electrospinning can be used as a better filter media for filtration of small aerosols, especially for nano-aerosols by diffusion and interception.

Under continuous aerosol loading to a filter, there is a tendency that the upstream side of the module layer is more loaded with aerosols as the aerosols that first captured there becomes artificial fibers that further enhance more capture of incoming aerosols. This also creates a “skin” layer for the upstream side of the filter wherein most of the aerosols are trapped; therefore, the pressure drop across the “skin” layer accounts for the majority of the pressure drop of the filter under depth filtration. On the other hand, the downstream side of the filter has progressively less aerosol loading. With continuous aerosol loading, eventually, the upstream skin layer becomes so clogged with trapping of incoming aerosols to the point that the trapped aerosols no longer stay in the filter but extends above the filter forming a cake layer above the filter surface. The cake layer formed by aerosols increases in thickness as more aerosols are trapped. Eventually, the cake becomes the effective filter media, and the original filter becomes the support of the growing cake layer.

With more incoming aerosols, the filtration efficiency of the filter keeps increasing, and the pressure drop across the filter keeps rising at an accelerating rate. Despite this, a large part downstream of the filter has not been fully utilized and has very little trapped aerosols. No matter how thick a filter is the rest of the filter thickness becomes redundant. Also, if the filter fibers are equipped with disinfectants for filtering aerosols that carried viruses, a large part of the filter becomes useless once the cake forms on the filter surface as all the aerosols are trapped in the growing cake and they are out of contact with the disinfectants in the filter.

Accordingly, there is a need in the art to have a high filtration filter which can significantly reduce or limit cake formation. Therefore, the filter can be used for a longer period of time while maintaining a low pressure drop across the filter without a significant reduction in filtration efficiency. Particularly, charged fibers typically become useless once the fiber is coated with trapped aerosols and the aerosols are normally distributed non-uniformly on the fiber surface and also non-uniformly across the filter from upstream to downstream of the filter. Despite a thick filter is used, the aerosols are trapped non-uniformly in the skin layer leaving a large downstream part of the filter not being utilized. Another need in the art is to increase the aerosol storage capacity of the nanofiber filter as the filter layer is typically only 0.5 µm to 20 µm in thickness and has much lower aerosols storage capacity as compared to microfiber filter with a thickness of 100 µm to several millimeters. More importantly, the trapped aerosols staying in the filter should be in contact with the disinfectants so that viruses carried by the filtered aerosols get killed. When a cake is formed, the viruses carried by the aerosols stay in the cake layer with no disinfection. Therefore, there is a need in the art to keep the aerosols in the filter (under depth filtration) and be in contact with the disinfection agent. In other words, there is a need in the art to extend depth filtration for a large part in the filtration process and reduce, if not entirely eliminate, cake or surface filtration. The captured aerosols should be uniformly distributed across the filter from upstream to downstream, reducing the skin effect fully utilizing the filter from upsteam to downstream. Further, the thickness of the filter should be increased to enhance the storage capacity of captured aerosols in the filter but in a way such that the full thickness of the filter medium be better utilized for capturing and storing the aerosols. Furthermore, other desirable features and characteristics will become apparent from the subsequent detailed description and the appended claims, taken in conjunction with the accompanying drawings and this background of the disclosure.

### SUMMARY OF THE INVENTION

Provided herein is a high filtration filter with effective disinfection and low pressure drop across the filter. It is the objective of the present disclosure to provide a filter that can significantly reduce or limit cake formation, thereby the filter can be used for a longer period of time serving the disinfection function while maintaining a low pressure drop across the filter without a significant reduction in filtration efficiency.

An aspect of the present disclosure is to provide a high filtration filter for filtering aerosols with effective disinfection and low pressure drop across the filter when the aerosols penetrate through from an upstream side to a downstream side for fully utilizing the filter thickness is disclosed. Another aspect of the invention is to overcome the disadvantage of nanofiber filter layer which is typically only 0.5 µm to 20 µm in thickness and is perceived to have much lower aerosols storage capacity as compared to microfiber filter with thickness of 100 µm to several millimeters. An aspect of the present invention is to provide a much higher storage capacity of aerosols as compared to conventional. Yet another aspect is the perception that charged fibers can easily be covered by aerosols such that the charged fibers subsequently become malfunction. An aspect of the present invention is to come up with a filter such that the charged fibers are fully utilized along the fiber and around the entire azimuthal orientation (360 degrees) of the fibers, and also for fibers in both upstream as well as downstream of the filter. The filter includes a plurality of module layers and a plurality of separators. An individual module layer is an electrostatically-charged polyvinylidene fluoride (PVDF) nanofiber mat. The electrostatically-charged PVDF nanofiber mat with charged nanofibers is configured to better capture aerosols. The plurality of module layers and the plurality of separators are alternatingly stacked and connected to one another. Each of the individual module layers has a moderate efficiency η of capturing 300 nm of sodium chloride aerosols at 5.3 cm/s of more than 40% and preferably greater than 50%) but with a quality factor QF of greater than 0.1/Pa, where QF = -1n(1-η)/Δp with Δp being the pressure drop across the filter. For a given fiber diameter, the fiber packing is adjusted so that these two criteria are met to minimizes the formation of a cake layer on the upstream side of the module layer. The criteria can be represented schematically in FIG. 16. For example, for a filter with large diameter nanofiber of 525 nm, the selected fiber basis weight is 0.765 gsm such that it is at least having the preferred efficiency of 61% greater than 40% (minimum) and in excess of preferred 50% but not too high, yet the pressure drop is only 5.1 Pa such that QF=-1n(1-0.61)/5.1=0.186/Pa > 0.1/Pa for the basic module. Given the efficiency 61% is not too high, any uncaptured aerosols are passed to the downstream module layer for filtering. This will distribute all incoming aerosol trapping uniformly across the entire filter from the upstream module layer to the downstream module layer. If the fiber basis weight is further increased both the efficiency and the pressure drop would have increased, QF may drop to a much lower level below the minimum of 0.1 /Pa. Note also if the fiber basis weight is below 0.765 gsm, the efficiency may be below the minimum of 40% and does not meet the set criterion. On the other hand for smaller fiber diameter of 349 nm, a module with a double layer of nanofibers (such that each of the layer has a fiber basis weight of 0.096 gsm with total of 0.191 gsm for both layers) has an efficiency for 300 nm aerosol of 57.9%, Δp of 6.1 Pa, and QF=0.142/Pa. This also meets the criteria of over 50% efficiency and with QF>0.1 Pa. If the gsm is doubled such that the basic module has one layer of charged PVDF nanofiber of 0.191 gsm, the efficiency of 300 nm aerosol is only 48.3%, which is less than the preferred of 50% margin despite the pressure drop of 4.9 Pa yielding QF=0.134/Pa. The decrease in efficiency is due to the additional electrical interference associated with the densely packed charged nanofibers. It will be apparent that as the nanofiber diameter is reduced, the fiber basis weight needs to be adjusted in order to meet the criterion for the single module of a multi-modular filter. These are two examples on the basic requirements for the single module or modular layer for both small and large diameter nanofibers, respectively. More modules are used in a filter and it will be clear in the following that another requirement is the multimodular filter should follow closely a constant QF condition as more modules are stacked to build-up the filter.

In certain embodiments, the individual module layer further comprises nanofibers having antimicrobials integrated for disinfecting the aerosols captured to achieve effective disinfection.

In certain embodiments, the antimicrobials are metallic oxides, natural disinfection materials, or chemical disinfectants.

In certain embodiments, the antimicrobials are selected from a group consisting AgO, ZnO, CuO, TiO₂, SnO₂, Al₂O₃, Fe₃O₄, chitosan, chlorides, peroxycarboxylic acids and inorganic peroxo acids, formaldehyde, glutaraldehyde, ortho-phthalaldehyde, or any combinations thereof.

In certain embodiments, the antimicrobials are in a form of nanoparticles with a size in a range between 0.1 times to 1 time of an average diameter of the charged nanofibers.

In certain embodiments, an individual separator comprises additional macro-pores for the separator to re-orient an airflow of the aerosols through the plurality of module layers from the upstream side to the downstream side.

In certain embodiments, an individual separator is anti-static and has good adhesion with the plurality of module layers.

In certain embodiments, the individual module layer with small average nanofiber has a fiber diameter of 0.05 µm to 0.35 µm and a fiber basis weight preferably in a range between 0.05gsm and 0.3gsm.

In certain embodiments, the individual module layer with large average nanofiber has a fiber diameter of 0.35 µm to 0.65 µm and a fiber basis weight preferably in a range between 0.4gsm and 0.99gsm.

In certain embodiments, the filter is configured to trap a majority of the aerosols inside the filter during depth filtration and a limited small controlled portion of the aerosols forms the cake layer during cake filtration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed, as illustrated by the embodiments hereinafter.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1A depicts a COVID-19 virus attached to a smaller carrier aerosol;

FIG. 1B depicts a COVID-19 virus attached to a large carrier aerosol;

FIG. 2A is a graph showing the pressure drop versus aerosol deposit;

FIG. 2B depicts a side view of a filter with a cake layer formed at the upstream side of the filter;

FIG. 3A is a setup for preparing PVDF nanofibers by electrospinning with a syringe connected to a high voltage supply;

FIG. 3B is a setup for charging a filter sample using corona discharge;

FIG. 4A depicts a side view of a high filtration filter in accordance with certain embodiments of the present disclosure;

FIG. 4B depicts a module layer of the high filtration filter with fibers having antimicrobials in accordance with certain embodiments of the present disclosure;

FIG. 5A is a graph showing the evolution of pressure drop of Filter 1 and Filter 2 versus the aerosol deposition;

FIG. 5B is a graph showing the evolution of pressure drop of Filter 2, Filter 3 and Filter 4 versus the aerosol deposition;

FIG. 6A is a graph showing the efficiency at 300 nm sodium chloride aerosol versus pressure drop across the four filters;

FIG. 6B is a graph showing the efficiency at 100 nm sodium chloride aerosol versus pressure drop across the four filters;

FIGS. 7A-B are the SEM images of the Filter 1 as seen from the upstream side;

FIGS. 7C-D are the SEM images of the Filter 1 as seen from the downstream side;

FIGS. 8A-B are the SEM images of the first layer of Filter 2 as seen from the upstream side;

FIGS. 8C-D are the SEM images of the second layer of Filter 2 as seen from the upstream side;

FIGS. 8E-F are the SEM images of the third layer of Filter 2 as seen from the upstream side;

FIGS. 8G-H are the SEM images of the fourth layer of Filter 2 as seen from the upstream side;

FIGS. 9A-B are the SEM images of the first layer of Filter 2 as seen from the downstream side;

FIGS. 9C-D are the SEM images of the second layer of Filter 2 as seen from the downstream side;

FIGS. 9E-F are the SEM images of the third layer of Filter 2 as seen from the downstream side;

FIGS. 9G-H are the SEM images of the fourth layer of Filter 2 as seen from the downstream side;

FIGS. 10A-B are the SEM images of the first layer of Filter 4 as seen from the upstream side;

FIGS. 10C-D are the SEM images of the second layer of Filter 4 as seen from the upstream side;

FIGS. 10E-F are the SEM images of the third layer of Filter 4 as seen from the upstream side;

FIGS. 10G-H are the SEM images of the fourth layer of Filter 4 as seen from the upstream side;

FIGS. 11A-B are the SEM images of the first layer of Filter 4 as seen from the downstream side;

FIGS. 11C-D are the SEM images of the second layer of Filter 4 as seen from the downstream side;

FIGS. 11E-F are the SEM images of the third layer of Filter 4 as seen from the downstream side;

FIGS. 11G-H are the SEM images of the fourth layer of Filter 4 as seen from the downstream side;

FIG. 12 is a table showing the pressure drop and deposit mass during depth filtration and cake filtration;

FIG. 13 depicts a side view of another high filtration filter in accordance with certain embodiments of the present disclosure;

FIG. 14 is a graph showing the efficiency at 300 nm sodium chloride aerosol versus pressure drop for different fiber diameter;

FIG. 15 is a graph showing the efficiency at 300 nm sodium chloride aerosol versus pressure drop for another two filter configurations;

FIG. 16 is a graph showing the preferred properties of a basic module;

FIG. 17 is a table summarizing the three basic modules of both small and large fiber diameter that satisfy the requirment of FIG. 16; and

FIG. 18 is a graph showing the efficiency at 300 nm sodium chloride aerosol versus quality factor for nanofiber of different diameters.

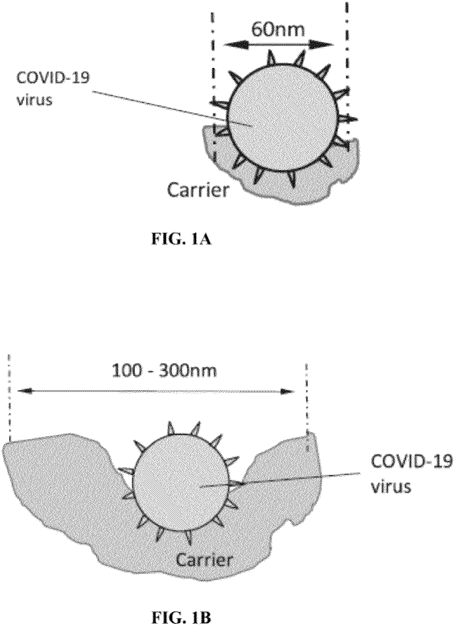

Skilled artisans will appreciate that elements in the figures are illustrated for simplicity and clarity and have not necessarily been depicted to scale.

### DETAILED DESCRIPTION OF THE INVENTION

The present disclosure generally relates to a high filtration filter with effective disinfection and low pressure drop across the filter. More specifically, but without limitation, the present disclosure provides an electrostatically-charged multilayer filter with fibers having antimicrobials which can significantly reduce or limit the cake formation. Furthermore, the filter can be used for a longer period of time while maintaining a low pressure drop across the filter without a significant reduction in filtration efficiency.

The terms “fiber basis weight” or “fiber packing density”, as used herein, are used with respect to a filter or a module layer in a filter to refer to the weight of the material (fiber) in the filter or module layer per unit surface area of the major surfaces of the filter or module layer.

In the specification and the appended claims, the term “gsm” as used herein is a unit of measure for the fiber basis weight of a subject and refers to “gram per square meter” or “g/m²”.

The term “nanofibers” as used herein refers to fibers that have a median size of less than 1 µm.

The term “pressure drop” refers to a reduction in static pressure within an airstream between the upstream side and the downstream ide of a filter through which the airstream passes.

The terms “upstream side” and “downstream side” as used herein are used to refer to the front side and the back side of the filter or each module layer of the filter, respectively.

The term “quality factor” as used herein, is used to measure the filtration performance of fibrous filters. It is a benefit-to-cost ratio (i.e. efficiency-to-pressure drop ratio). The quality factor is defined by:

$$Q F = \frac{- ln \left(1 - η\right)}{Δ p} \qquad \text{(1)}$$

For constant QF, the equation can be rewritten as:

$$η = 1 - e x p \left(- Q F Δ p\right) \qquad \text{(2)}$$

The term “filtration efficiency” of a filter as used herein is a concept that quantifies the performance of all the numerous fibers to challenging air stream containing aerosols or particles. The single fiber efficiency is the equivalent efficiency of a single fiber in the filter per unit filter volume. It has factored in the fiber packing density, filter thickness, average fiber diameter and the filter efficiency. The single fiber efficiency is composed of two parts: (a) single fiber efficiency due to mechanical capture and (b) single fiber efficiency due to dielectrophoretic effect (inducing dipole on neutrally charged particles and capturing them by a charged fiber). These two capture mechanisms are additive assuming they capture independently the neutrally charged particles carried by the airflow. By subtracting the mechanical portion from the total single fiber efficiency, one can come up with the single fiber efficiency based on the dielectrophoretic effect alone. This index only measures electrostatic interactions between charged fiber and neutrally charged particles. It is independent of the fiber packing density, fiber diameter, and filter thickness. An electret filter, irrespective of the fiber packing density/basis weight, fiber diameter, filter thickness, and filter efficiency, has a higher performance due to electrostatic effect if the single fiber efficiency based on the dielectrophoretic effect is higher. It is a convenient way to compare electret filters of different configurations.

The term “charged” as used herein means that an object has a net electrostatic charge, positive or negative polarity, relative to uncharged objects or those objects with no net electrostatic charge.

Furthermore, as used herein, the term “about” or “approximately”, when used in conjunction with a numerical value or range of values, refers preferably to a range that is within 10 percent, preferably within 5 percent, or more preferably within 1 percent of a value with which the term is associated. The use of any and all examples, or exemplary language (e.g., “such as”) provided herein, is intended merely to better illuminate the invention and does not pose a limitation on the scope of the invention unless otherwise claimed.

Unless specified otherwise, the terms “comprising” and “comprise”, and grammatical variants thereof, are intended to represent “open” or “inclusive” language such that they include recited elements but also permit the inclusion of additional, unrecited elements.

When continuously using a filter (such as a face mask) and loading aerosols thereto, there is a tendency that the upstream side of each module layer in the filter is more loaded with aerosols as the aerosols that first captured there forms a “skin” layer. Eventually, the upstream skin layer becomes so clogged with trapping of incoming aerosols to the point that a cake layer is formed on the filter surface. The cake layer formed by aerosols increases in thickness as more aerosols are trapped. The filtration efficiency keeps increasing, and concurrenty the pressure drop across the filter keeps rising at an accelerating rate.

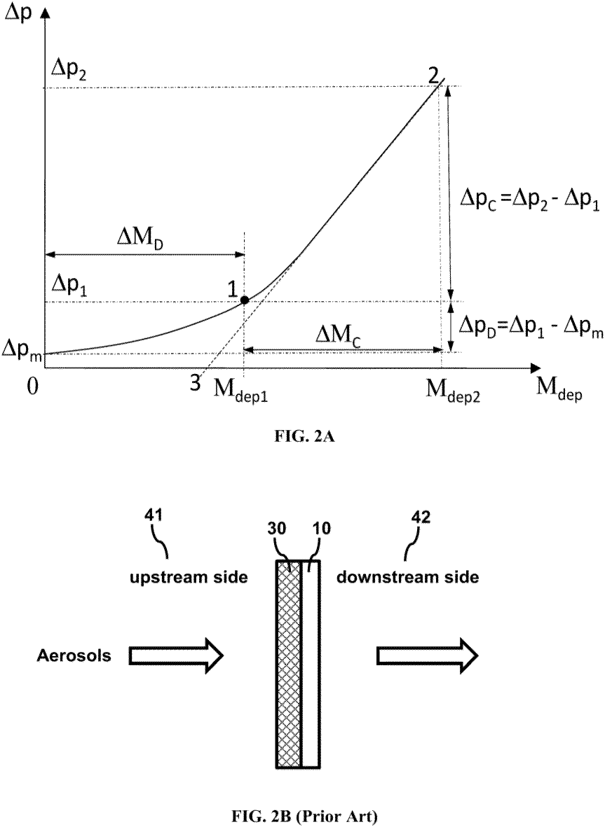

FIG. 2A is a graph showing the pressure drop Δp across the filter (filter and the cake layer) versus aerosol deposit, which is the deposited cake mass M_{dep} in g/m² filter area. FIG. 2B shows a conventional filter 10 with a cake layer 30 formed at the upstream side 41 of the filter 10. Δpₘ designates the pressure drop due to a clean filter 10 without deposited mass (M_{dep}=0). As more aerosols are being deposited, Δp increases until reaching point “1”, at which a cake layer 30 starts to form on the filter surface. From this point onward, as more aerosols are captured, the cake layer 30 increases in thickness, the filter 10 is then characterized in that cake filtration is observed and Δp is increased typically linearly with increasing ΔM_{dep}. The permeability of the cake layer 30 that forms the effective filter can be determined from the slope of the linear behavior. As Δp reaches the operation prescribed limit at Δp₂, the filtration operation is stopped at which point the filter 10 should either be cleaned or otherwise be replaced.

In particular, the depth filtration, where aerosols are trapped in the filter 10, is typically shorter and constitutes approximately 30% or less of the aerosol deposit. For the cake filtration, where aerosols are trapped in the cake layer 30, is typically longer and constitutes approximately 70% or more of the aerosol deposit. Therefore, the aerosols trapped in the filter 10 under depth filtration are designated as M_{dep1}, and the aerosols trapped in the cake layer 30 above the filter is designated as “M_{dep2}-M_{dep1}”.

Commercial surgical masks are designed with filtration fibers of relatively large diameter, which is around 1 µm to 20 µm. The filtration fibers are made of melt-blown filter media inserted between two non-woven fabrics, and are responsible for maintaining a balance between filtration and pressure drop. Such a surgical mask must pass the American Society for Testing and Materials (ASTM) standards for fluid protection, which can protect the wearer from contact with aerosols, droplets, splashes and sprays that may contain virus. A typical 3-layer surgical mask has a fiber packing density in the range of 20gsm to 25gsm. Some other high filtration filters are designed using electrostatically-charged fibers of fine dimension. The fibers mostly are microfibers arranged with high fiber packing density but it can be nanofibers with lower fiber packing density.

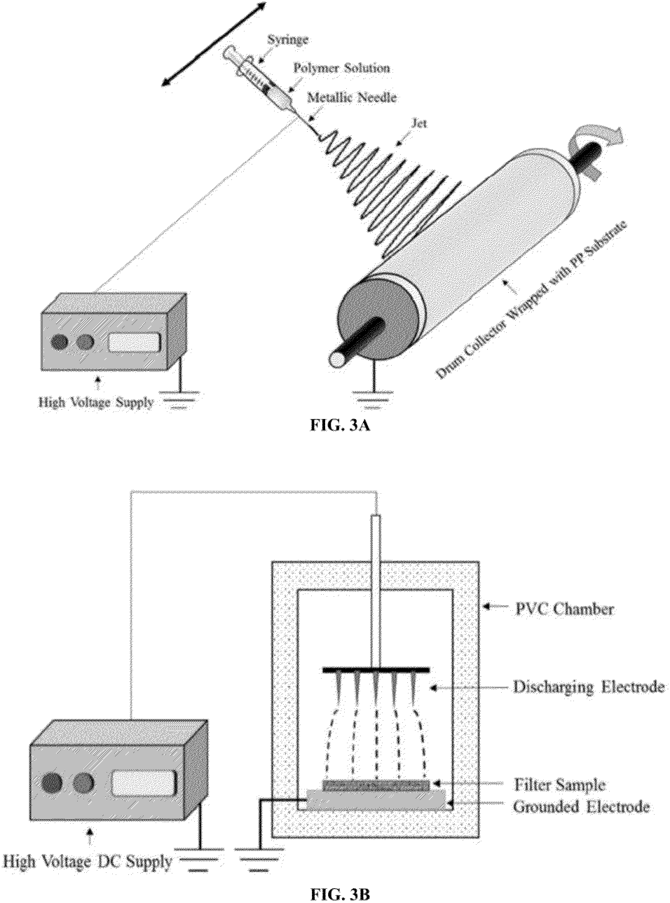

In accordance with the present disclosure, electrostatically-charged polyvinylidene fluoride (PVDF) nanofibers are used to develop the high filtration filter 100. FIG. 3A shows the setup for preparing PVDF nanofibers by electrospinning. PVDF pellets are first dissolved in a solvent mixture of dimethylformamide and acetone solvent for 24 hours under 70° C. The typical ingredient for the precursor solution is 20% g of PVDF solute in 100 mL of solution (20 %w/v). The well-mixed precursor solution is fed to a syringe connected to a high voltage supply of approximately 20kV. The ground collector is placed at 15 cm from the syringe tip. A controlled amount of PVDF solution (0.9 mL/h) is delivered by the syringe using the syringe pump to establish a droplet at the syringe tip. Under the strong electrostatic field, the droplet takes on the shape of a Taylor cone. Once the electrostatic force acting on the cone-shape droplet has overcome the surface tension force acting on the droplet, a jet is sent out through the cone-shape droplet towards the collector. During the free flight, the jet continues to thin out in diameter as the solvent is continuously being evaporated and the “positive” electrical charges deposits along the jet repelled against each other, thereby further stretching out the fiber jet and reducing the fiber diameter. When the fiber jet lands onto the substrate laid over the collector surface, the fiber reduces in diameter in the range of nanofiber (< 1 µm). In order to get a uniform nanofiber mat, a rotating drum collector can be used with a rotation speed of about 10 rev/min. The thickness of the nanofiber mat can be customized by changing the time duration of electrospinning. The relative humidity is maintained at 40 ± 2% to control the evaporation rate during electrospinning. The nanofiber mat is then dried in an oven overnight at 40° C. for curing to allow the residual solvent to be evaporated. Despite FIG. 3A shows the production of nanofibers using a single syringe, it is apparent that needless electrospinning (not shown), which is equivalent to thousands of needles operating concurrently, may also be used for producing nanofiber mat on a commercial scale.

In order to electrostatically-charged the nanofiber mat, corona discharge is performed as depicted in FIG. 3B. Corona discharge is an electrical discharge to the nanofiber mat by ionization of the surrounding air or other fluid using a conductor at high voltage and close distance. A plurality of discharging electrodes is used to impart electrostatic charges to a PVDF nanofibers mat from a distance, for example, at 30 mm away. The charging voltage is 15kV, and the charging time is about 1 minute. The condition may also be optimized to impart the maximum amounts of space charges uniformly and stably onto the PVDF nanofiber mat to avoid burning of the mat locally. Charge is emitted around the energized discharging electrodes and deposited on the PVDF nanofiber mat under the influence of the electric field to obtain an electrostatically-charged PVDF nanofiber mat.

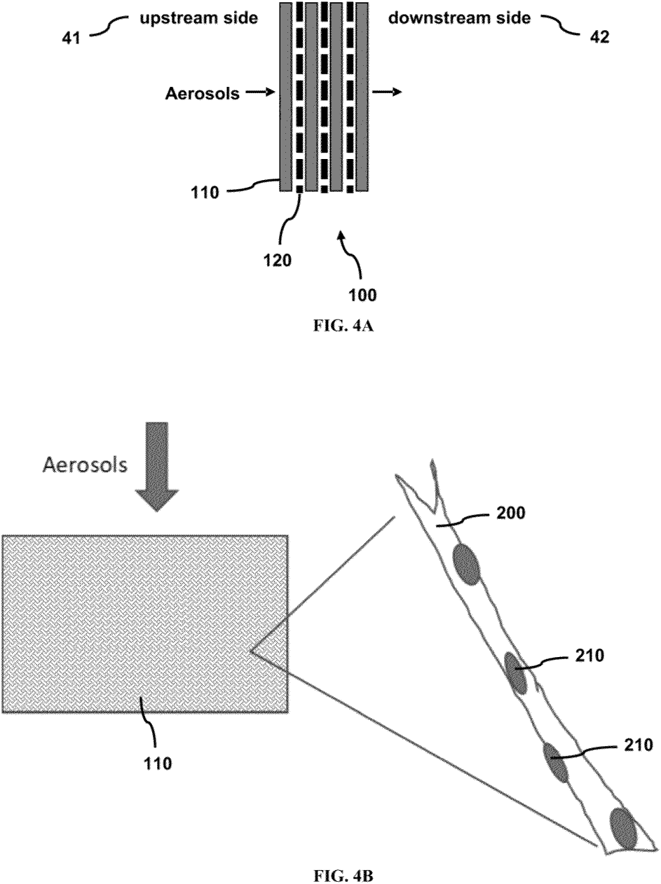

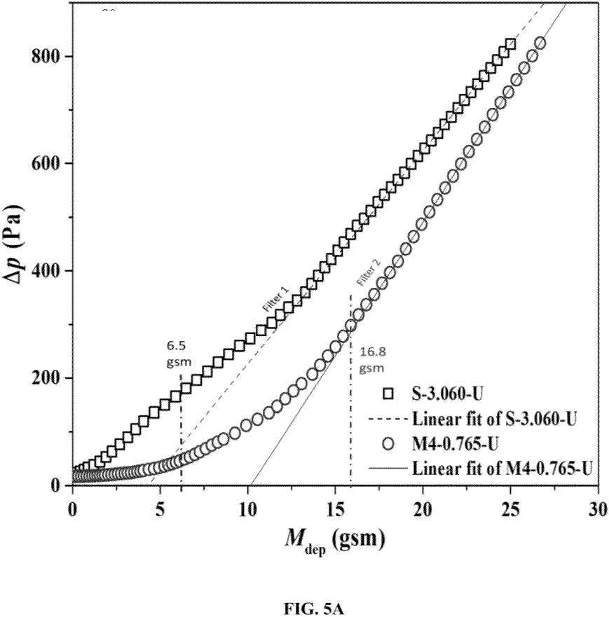

FIG. 4A depicts the high filtration filter 100 developed from the electrostatically-charged PVDF nanofiber mat with electrospun nanofibers. The high filtration filter 100 has effective disinfection capability and low pressure drop across the filter 100 when aerosols penetrate through. The high filtration filter 100 comprises a plurality of module layers 110 and a plurality of separators 120, the plurality of module layers 110, and the plurality of separators 120 are alternatingly stacked and connected to one another. Each individual module layer 110 is an electrostatically-charged PVDF nanofiber mat with fiber basis weight adjusted such that for a given fiber diameter the module layer 110 has only a modest efficiency >50%, low pressure drop and resulting QF > 0.1/Pa. In contrast, the conventional nanofiber filters, which typically are 0.5 µm to 20 µm in thickness, are perceived to have much lower aerosols storage capacity but have efficiency at least 80%. The high filtration filter 100 provides a much higher storage capacity of aerosols as compared to conventional. The purpose of having a modest efficiency for each module layer 110 is to minimize the formation of skin effect leading to forming a cake layer 30 on the upstream side 41 of each individual module layer 110 of the filter 100. The plurality of module layers 110 is separated by separators 120 or scrim material. The separator 120 is configured to provide support for the module layer 110 and preferably, the separator 120 is antistatic so that the separator 120 has good adhesion with the module layer 110. Furthermore, the separator 120 provides insulation between module layers 110 for reducing electrical interference from the charged fibers. The separator 120 provides additional macro-pores instead of micropores provided by the nanofibers, and so the separator 120 can re-orient the airflow of the aerosols through the plurality of module layers from an upstream side 41 to a downstream side 42 of the filter 100 for fully utilizing the filter thickness. Furthermore, the capturing mechanism in the filter 100 is by means of diffusion, while the electrostatic charges help to trap aerosols uniformly during depth filtration and over the entire circumference of the fiber. Consequently, the filter 100 can trap a majority of the aerosols (up to 70%) inside the filter 100 and only a small portion of the aerosols (about 30%) may form the cake layer 30, thereby the cake layer 30 formation is significantly reduced or limited, and the filter 100 can be used for a longer period of time. Although in the illustrated embodiment, the filter 100 comprises four module layers 110 and three separators 120 arranged alternatingly stacked and connected to one another, it is apparent that the number of module layers 110 and separators 120 may be otherwise without departing from the scope and spirit of the present disclosure. For example, the filter 100 may comprise five module layers 110 and four separators 120, or six module layers 110 and five separators 120.

FIG. 4B shows the module layer 110 of the high filtration filter 100 with electrospun nanofibers 200 having antimicrobials 210, for disinfecting bacteria, viruses, and harmful microbials carried by the trapped aerosols in the filter 100. Aerosols, including aerosolized droplets, may contain microbial in the form of viruses. This is the main mode of transmission of coronavirus (COVID-19, SARS, MERS, etc.), flu viruses, measles virus, small bacteria (e.g. B. pertussis), fungi and other airborne toxins (e.g. endotoxins). If the filter 100 has antimicrobials 210 integrated into the nanofiber 200 during electrospinning, the antimicrobials 210 have to be in contact with the trapped aerosols containing microbial in order to kill the microorganisms. The antimicrobials 210 can be metallic oxides or natural disinfection materials. In certain embodiments, these antimicrobials 210 can be particles made of AgO, ZnO, CuO, TiO₂, SnO₂, Al₂O₃, Fe₃O₄, other natural materials (e.g. chitosan), chlorides, peroxycarboxylic acids and inorganic peroxo acids, formaldehyde, glutaraldehyde, ortho-phthalaldehyde, or any combinations thereof.

As discussed in greater detail below, the antimicrobials 210 are in the form of nanoparticles with size in the range of 0.1 times to 1 time of the average diameter of the nanofiber 200. The antimicrobials 210 can be placed in the precursor solution of PVDF and allow the antimicrobials 210 to perform electrospinning. As PVDF forms nanofiber 200, these nanoparticles will be incorporated into the nanofiber 200. When the proper size range of the antimicrobials 210 are selected, most of these antimicrobials 210 are partially exposed on the surface of the nanofiber 200. When aerosols or respiratory droplets carrying virus or bacteria are trapped by the nanofibers 200, the viruses or bacteria are in contact with the antimicrobials 210 and get deactivated or killed. Otherwise, viruses such as COVID-19 can stay under room temperature between 2-7 days, and at 4° C. (refrigerator) for as much as 14 days.

However, once the aerosols deposited on the upstream side 41 of each individual module layers 110 of the filter 100 to form a cake layer 30, the antimicrobials 210 will not be effective in contact with the incoming aerosols. Therefore, the disinfection function by the antimicrobials 210 of the filter 100 is lost. Therefore, it is advantageous to have a high filtration filter 100 that will not form a cake layer 30 easily. Further, the nature of being electrostatically-charged can result in fibers easily covered by aerosols, such that the charged fibers subsequently become malfunction. The high filtration filter 100 has the advantage that the charged nanofibers 200 are fully utilized along the filter thickness from the upstream side to the downstream side, and around an entire azimuthal orientation of the fibers.

For demonstrating the advantages of the present disclosure, four filters with different configurations were used to compare the filtration performance. Filter 1 is made of uncharged nanofibers with a fiber diameter of 525 nm average, and has a fiber basis weight of 3.06gsm packed into a single module 110. Filter 2 is made of uncharged nanofibers with a fiber diameter of 525 nm average, and the fibers are arranged in four module layers 110 with each module layer 110 having a fiber basis weight of 0.765gsm. Filter 3 is made of electrostatically-charged nanofibers with a fiber diameter of 525 nm average, and has a fiber basis weight of 3.06gsm packed into a single module 110. Filter 4 is made of electrostatically-charged nanofibers with a fiber diameter of 525 nm average, and the fibers are arranged in four module layers 110 with each module layer 110 having a fiber basis weight of 0.765gsm. As it is apparent that the Filter 4 has fiber packing density reduced to facilitate aerosols to further penetrate deeper into the filter. Unlike Filter 2, Filter 4 further includes charged nanofibers with better capture of aerosols. As a result, it is expected that Filter 4 has the highest aerosol deposited into the filter before forming a cake layer 30. Although a fiber basis weight of 0.765gsm is used to perform the analysis, it is apparent that the fiber basis weight shall not be limited to such a particular fiber basis weight. In certain embodiments, the individual module layer 110 has a small average nanofiber with fiber diameter in the range of 50 nm to 350 nm. The fiber basis weight is preferably in the range between 0.05gsm and 3gsm. In another embodiment, the individual module layer 110 has a large average nanofiber with fiber diameter in the range of 350 nm to 650 nm. The respective fiber basis weight is preferably in the range between 0.4gsm and 0.99gsm. In both situations, the basic module meets the requirements of modest efficiency of at least 50% efficiency for 300 nm aerosol and low pressure drop such that QF > 0.1/Pa.

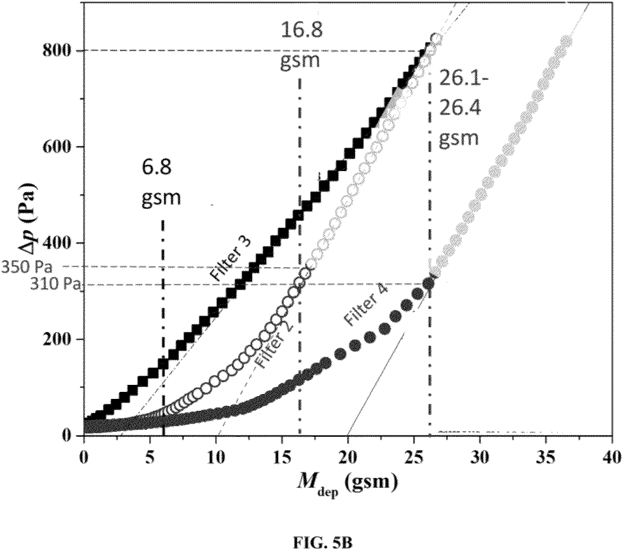

Refer to FIG. 5A, Filter 1 and Filter 2 are compared on the evolution of pressure drop Δp versus the aerosol deposition. Filter 2 has 16.8gsm of aerosol deposited in the filter before forming a cake layer 30, whereas Filter 1 has a higher fiber packing density, and only 6.5gsm of aerosol deposited in the filter after which a cake starts to form on the filter surface.

Refer to FIG. 5B, Filter 2, Filter 3, and Filter 4 are compared on the evolution of pressure drop Δp versus the aerosol deposition. Filter 4 has 26.1gsm of aerosol deposited in the filter before a cake layer 30 starts to develop, whereas Filter 3 has a higher fiber packing density with charged nanofibers and only 6.8gsm of aerosol deposited in the filter prior to cake formation. Filter 2 has uncharged nanofibers, although the packing density is the same as Filter 4. The charged nanofibers for Filter 4 provide more uniform aerosol capture along the fiber length and around the fiber periphery. Therefore, Filter 4 has significantly higher aerosol deposition than Filter 2.

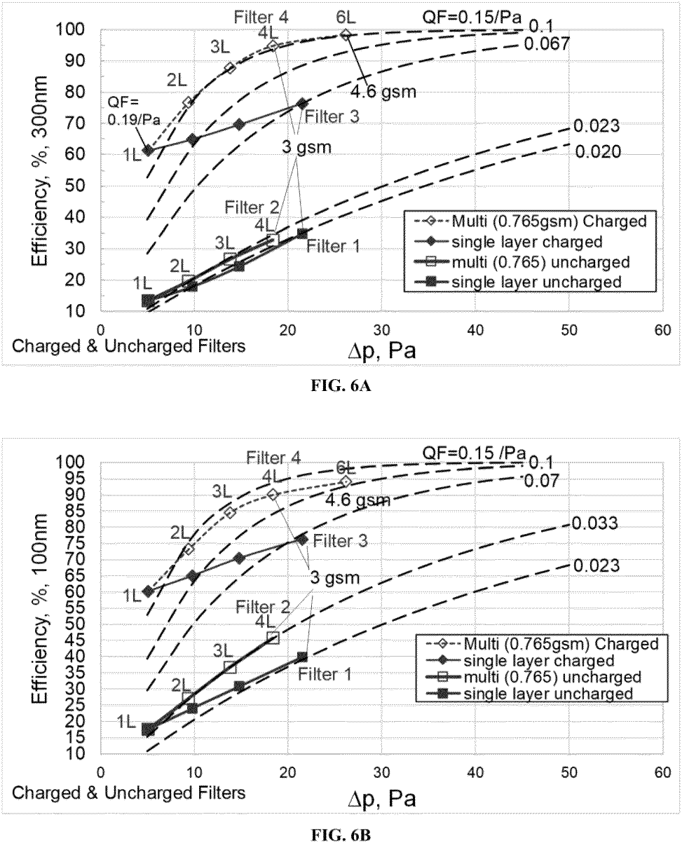

FIG. 6A shows the efficiency at 300 nm sodium chloride aerosol versus pressure drop across the four filters without aerosol loading (i.e. clean filter). Filter 1 has an efficiency of 34.8% with Δp of 21.5 Pa. The QF for uncharged Filter 1 is very low at 0.02/Pa. For uncharged Filter 2, the basis weight of each module layer is 0.765gsm, and four module layers are alternatingly stacked and connected together. The QF for Filter 2 is also low at 0.023/Pa. The efficiency is approximately 32.8% with Δp of 18.4 Pa. Comparing with Filter 1, the pressure drop is reduced by 17% while the efficiency is reduced by 6%.

Referring to FIG. 6A, Filter 3 is a charged single module with 3.06gsm basis weight. The efficiency is about 76.3% with Δp of 21.5 Pa. The benefit of higher basis weight on efficiency is marginal due to the interference of fibers all packed in a single module. The QF for Filter 3 is 0.067/Pa. For Filter 4, charged nanofibers are used and distributed in each module layer, each with 0.765gsm. The efficiency is about 94.7% with Δp of 18.4 Pa. The QF for Filter 4 is 0.15/Pa. Comparing with Filter 3, the pressure drop is reduced by 17% while the efficiency is increased by 24%. The benefit of higher basis weight on efficiency is largely due to a reduction in electrical interference of charged fibers. An important point is that in building up Filter 4 using the basic module having η=57.9% and QF=0.142/Pa, Filter 4, which is a stack-up of 4 basic modules, has QF=0.15/Pa following the constant QF behavior. As can be seen in FIG. 6A, 1 module, 2 modules, 3 modules and 4 modules of charged fibers with 0.765gsm fibers in each module all follow the constant QF curve (i.e. iso-QF) of 0.15/Pa. This is unlike Filter 3, as the basis weight increases from 0.765 gsm to 3.06 gsm, QF drops from 0.142/Pa down to 0.067/Pa which does not follow the constant QF behavior. This is because as more nanofibers are installed per layer, there is more electrical interference among neighboring charged nanofibers, which reduce the efficiency, and the QF accordingly.

A similar result is also observed when 100 nm aerosols are used instead of the 300 nm aerosols, as shown in FIG. 6B.

For comparing the aerosol capture performance, scanning electron microscope (SEM) images with sodium chloride deposited in the four filters were analyzed. Generally, the sodium chloride can be seen in each of the module layers 110 from the upstream side 41 to the downstream side 42, and in front of the fiber when viewing from the upstream side 41 or behind the fiber when viewing from the downstream side 42.

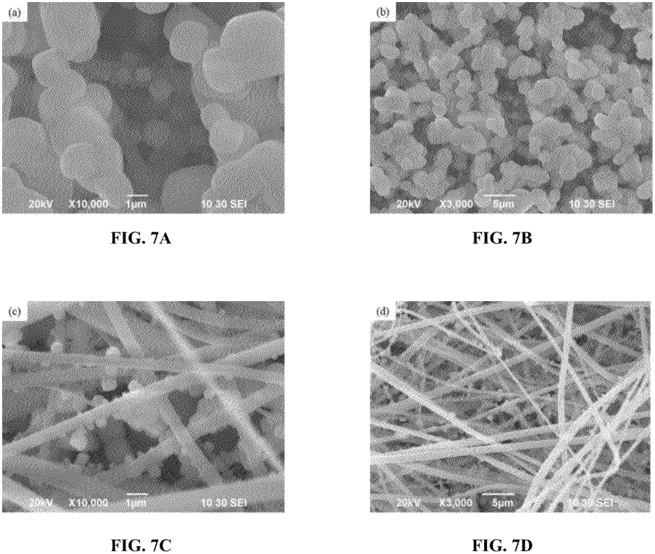

FIGS. 7A-B are the SEM images of the Filter 1 as seen from the upstream side 41, while FIGS. 7C-D are the SEM images of Filter 1, as seen from the downstream side 42. Filter 1 has depositions in the single module layer on the upstream side 41, while the downstream side 42 has very little sodium chloride deposition. Therefore, a cake layer 300 is formed on the upstream side 41 to block the flow into the filter.

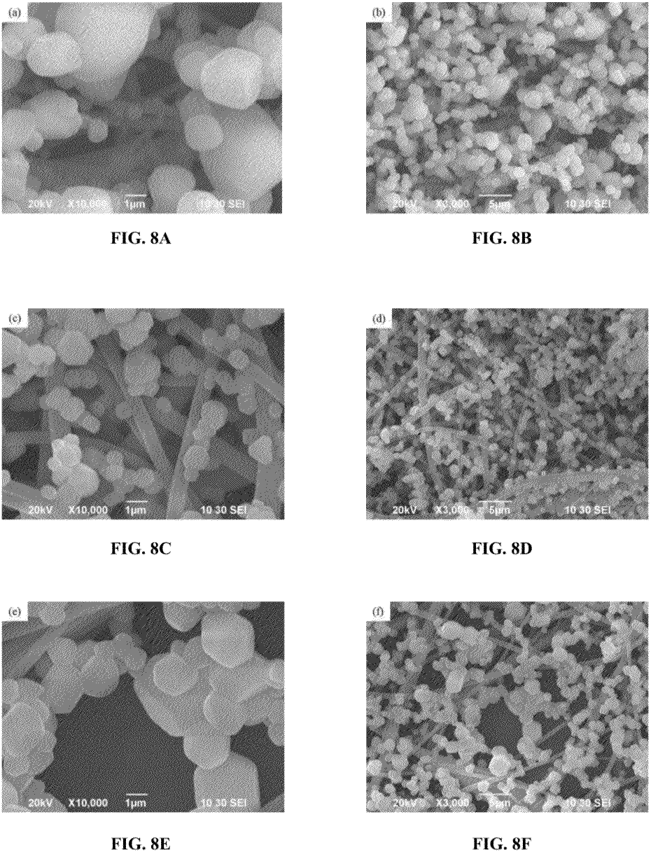

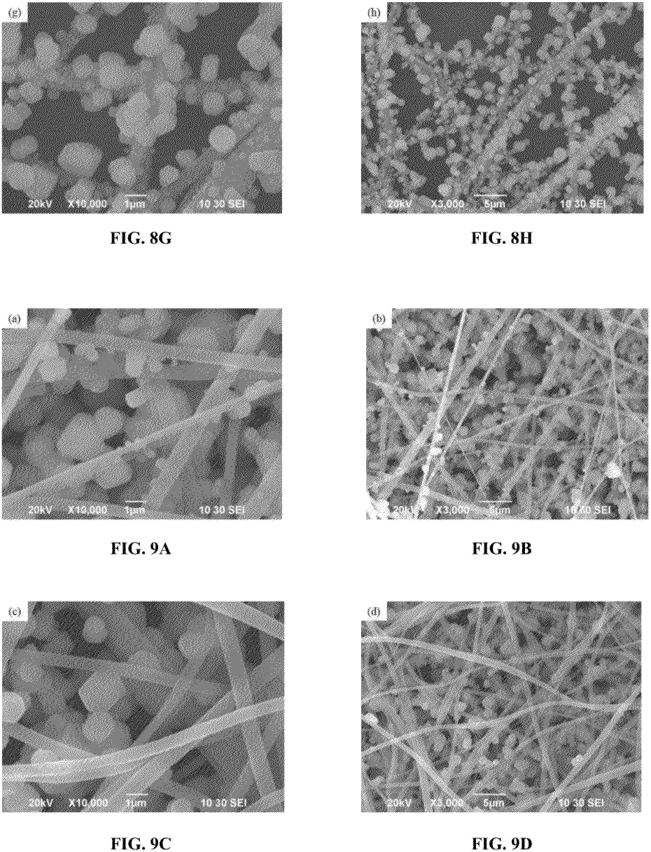

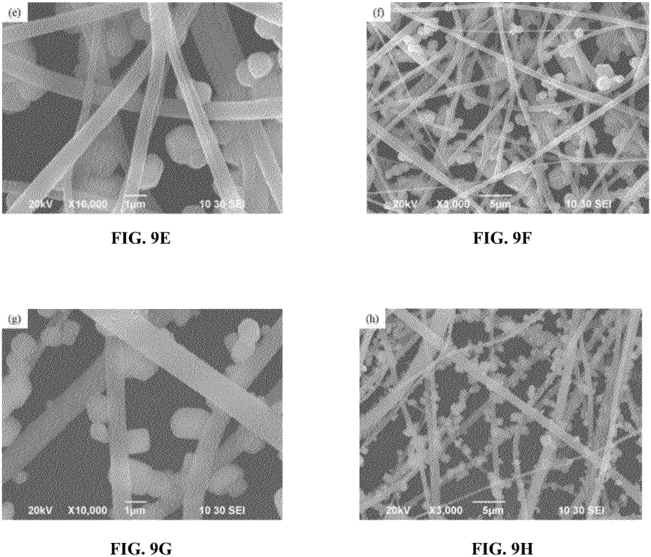

FIGS. 8A-B, FIGS. 8C-D, FIGS. 8E-F, and FIGS. 8G-H are the SEM images of each module layer of the Filter 2 as seen from the upstream side 41, while FIGS. 9A-B, FIGS. 9C-D, FIGS. 9E-F, and FIGS. 9G-H are the SEM images of each module layer of the Filter 2 as seen from the downstream side 42. Filter 2 with uncharged nanofibers has depositions mainly on the windward side of each module layer and leaving the leeward side untouched.

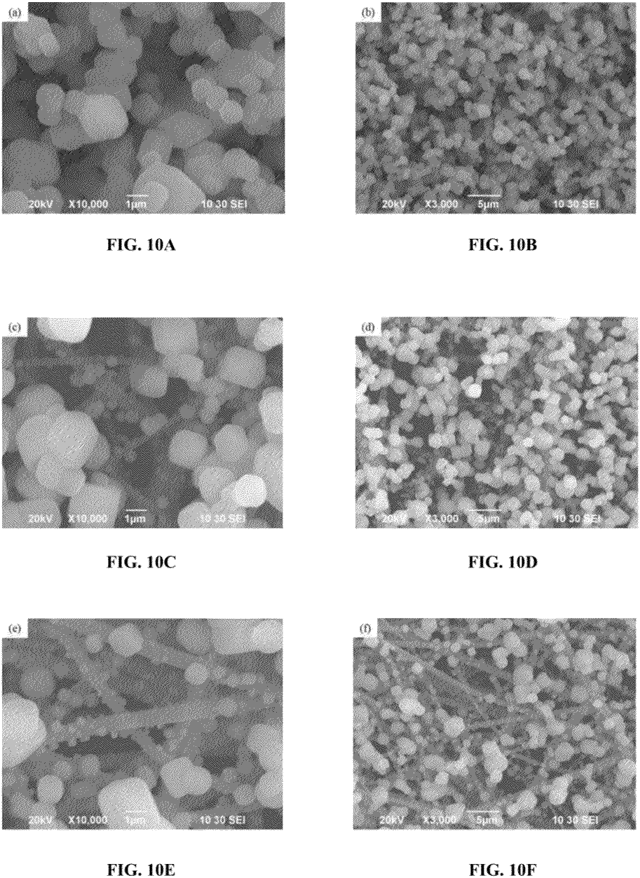

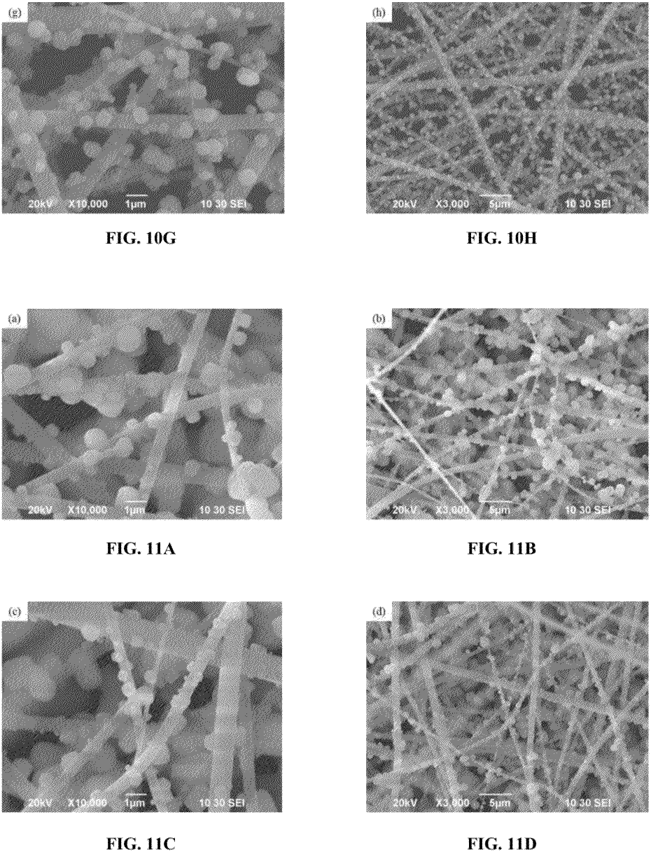

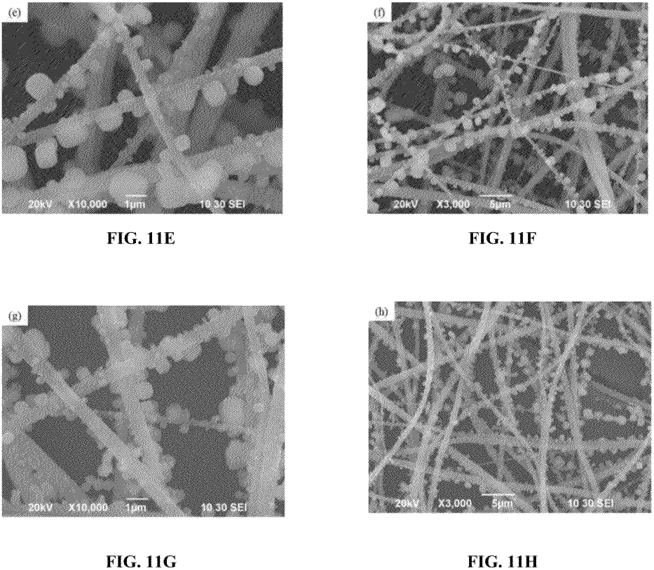

FIGS. 10A-B, FIGS. 10C-D, FIGS. 10E-F, and FIGS. 10G-H are the SEM images of each module layer of the Filter 4, as seen from the upstream side 41, while FIGS. 11A-B, FIGS. 11C-D, FIGS. 11E-F, and FIGS. 11G-H are the SEM images of each module layer of the Filter 4 as seen from the downstream side 42. Filter 4 with charged nanofibers has depositions in each of the four layers from upstream to downstream layer, and in front of the fiber as well as behind the fibers. Therefore, there are more deposits for Filter 4 with charged nanofibers as compared to Filter 2 with uncharged nanofibers despite that both are having 4 module layers 110. The modest efficiency (>50%) together with the smaller fiber packing with low pressure drop in Filter 2 and Filter 4 allows the aerosol to penetrate the filter easier, and there is a lower tendency for the formation of a cake layer 300.

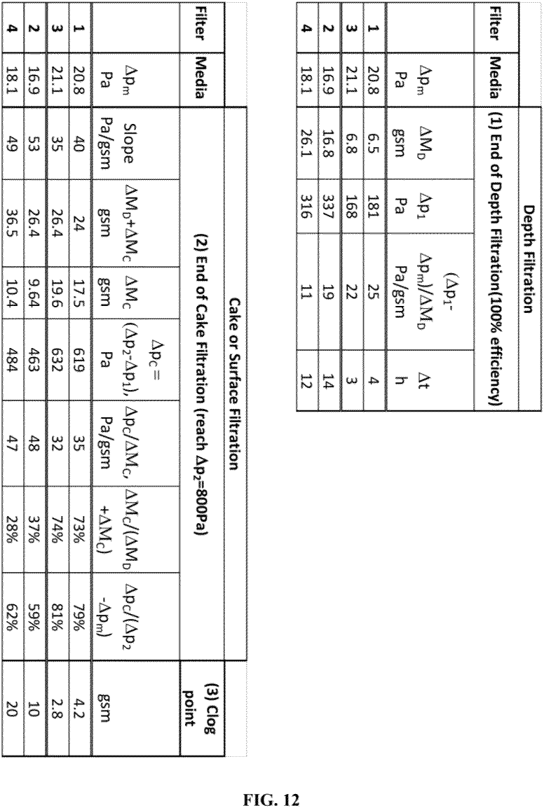

FIG. 12 provides a table summarizing the amount of aerosol being deposited in the four filters, respectively, in the depth filtration and in the cake filtration. All four filters have the same amount of fibers of 3.06gsm. The maximum pressure drop Δp₂ imposed on all 4 filters is 800 Pa at which the filtration is stopped, and the filter has to be cleaned or replaced.

Filter 1 with uncharged fibers all in a single module has 6.5gsm of deposit in the filter during depth filtration and 17.5gsm of deposit in the cake layer 300. Therefore, 27% of the total aerosol deposit is in the filter and 73% in the cake layer 300. The pressure per increase in the deposit (Δp/ΔM), which is used to determine how fast the pressure escalates per unit of aerosol deposition, is 25 Pa/gsm during depth filtration.

Filter 3 with charged fibers all in a single module has 6.8gsm of deposit in the filter during depth filtration and 19.6gsm of deposit in the cake layer 300. Therefore, 26% of the total aerosol deposit is in the filter and 74% in the cake layer 300. The performance is comparable to that of Filter 1. During depth filtration, Δp/ΔM is 22 Pa/gsm.

Filter 2 with uncharged fibers arranged in four modules has 16.8gsm of deposit in the filter during depth filtration and 9.64gsm of deposit in the cake layer 300. Therefore, 63% of the total aerosol deposit is in the filter and 37% in the cake layer 300. During depth filtration, Δp/ΔM is 19 Pa/gsm.

Filter 4 with charged fibers arranged in four modules has 26.1gsm of deposit in the filter during depth filtration and 10. 4gsm of deposit in the cake layer 300. Therefore, 72% of the total aerosol deposit is in the filter and 28% in the cake layer 300. During depth filtration, Δp/ΔM is only 11 Pa/gsm, which is smaller than Filter 1 by 2.27 times.

From the analysis of the four filter configurations, the charged nanofiber distributing in four module layers 110 can stop the filtration operation at the incipient point of forming a cake layer 300, and the deposited aerosols are stored within the filter. If the aerosols contain microbes such as virus, bacteria, fungi, and antitoxins, the microbial can be disinfected by the antimicrobials 210 integrated into the nanofiber 200. The overall pressure drop is also low, with only 310 Pa. This shows a significant contrast with Filter 3, which can only capture 6.8gsm within the filter for the antimicrobials 210 to disinfect. The trapped aerosols stored in the cake layer 300 can escape from disinfection.

Another important point is that a new European standard is being setup to test electrostatically charged filter with the understanding that when significant aerosols are deposit in the filter especially when a cake layer 300 is formed, the charged filter 100 becomes useless. In consequence, a new filter testing standard has been designed to test the filter with an electrostatic charge and after electrostatics being discharge. Filters are compared based on their discharge state. According to the present disclosure, the charge in the multimodule filter can be used for a much longer period for which aerosols do not cover the charged fibers in these modules, and the cake layer 300 formation is being significantly reduced or limited. More importantly, all captured aerosols stay within the filter and can be disinfected. The new European filter test becomes irrelevant and should not be applicable to this new filter.

The Filter 4 multimodule structure operates exclusively under depth filtration with all deposit in the filter that can be disinfected. The pressure drop is 316 Pa, and so after depositing 26 gsm, the pressure drop is reduced by approximately 61% from 800 Pa to 316 Pa.

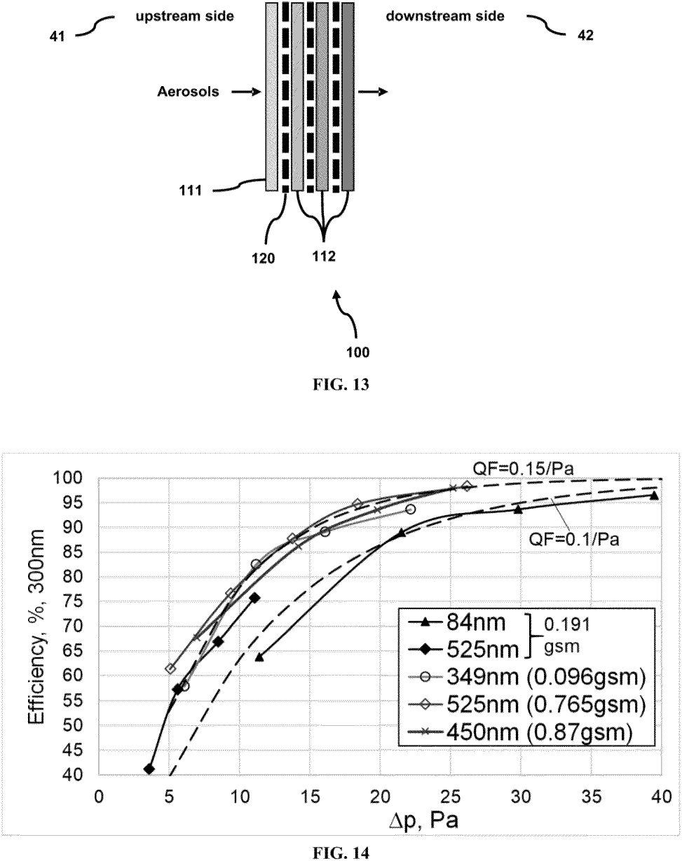

FIG. 13 shows another embodiment of the present disclosure. The high filtration filter 100 comprises a plurality of module layers 110 stacked together, each module layer 110 is an electrostatically-charged PVDF nanofiber mat with a low fiber packing density. The plurality of module layers 110 comprises an incipient module layer 111 and one or more subsequent module layers 112. The incipient module layer 111 is arranged at the upstream side 41 receiving the aerosols. The one or more subsequent module layers 112 are arranged further downstream for the aerosols to pass through from the incipient module layer 111. In the illustrated embodiment, there are three subsequent module layers 112 arranged after the incipient module layer 111, and it is apparent that there may be more or fewer subsequent module layers 112 to achieve a particular filtration performance without departing from the scope and spirit of the present disclosure. The first module layer has the smallest fiber packing density to minimize the formation of a cake layer 300; the subsequent module layers 112 have a higher fiber packing density. The increase in fiber packing density from the incipient module layer 111 to the subsequent module layers 112 may be linear or stepwise. Each of the subsequent module layers 112 may have the same or different properties. The varying properties may be the basis weight, fiber diameter, or fiber thickness.

A common mass balance equation is:

$$\text{W} = \left(α\right) \left(\text{h}\right) \left({ρ}_{\text{f}}\right) \qquad \text{(3)}$$

wherein, α is the fiber volume per bulk volume pf the nanofiber filter (excluding the support substrate); ρ_{f} is the density of the material (PVDF is 1780 kg/m^3); W is the fiber packing density; h is the filter thickness; and d_{f} is the fiber diameter.

If the fiber packing density varies, the filter thickness can also vary. Once the fiber packing density and the fiber diameter are fixed, the fiber volume can be determined. Note the fiber diameter d_{f} does not enter the above mass balance equation.

While the foregoing demonstrates that when loading a multiple module filter, it is important for the clean and unused filter to have high efficiency and low pressure drop (i.e. high quality factor) so that it will have the benefit for the loaded filter. In the above detailed example, a 525 nm diameter filter has been used as a demonstration. The fiber basis weight is 0.765gsm. Another filter with the same fiber diameter but with a lower fiber basis weight of 0.191gsm is used as shown in FIG. 14. In FIG. 14, after stacking 4 module layers, the efficiency for the 525 nm filter (4 modules X 0.191gsm/module) for 300 nm aerosol can only achieve 76% efficiency with a pressure drop of 11.1 Pa and QF=0.1281/Pa, which is much below than the 525 nm filter (4 modules X 0.765gsm/module) with 95% efficiency and QF of 0.1598/Pa. Afterall, the basic module for the 525 nm filter with 0.191 gsm has an efficiency of 41.2% which does not the preferred requirement of at least 50% efficiency despite the pressure drop is low at 3.6 Pa, and QF>0.⅟Pa. Alternatively, another filter with 450 nm diameter and each module with a fiber basis weight of 0.87gsm has efficiency for 300 nm of 67.7% and presure drop of 7 Pa and QF of 0.16/Pa. After stacking 4 modules, the filter can achieve 98% efficiency for the 300 nm aerosol but with a pressure drop of only 25.2 Pa resulting in QF=0.155/Pa. Both of these clean unloaded filters during module stack-up 2, 3 and 4 show the filters all having QF that closely follows 0.15/Pa which are good candidates for the modular filter for loading.

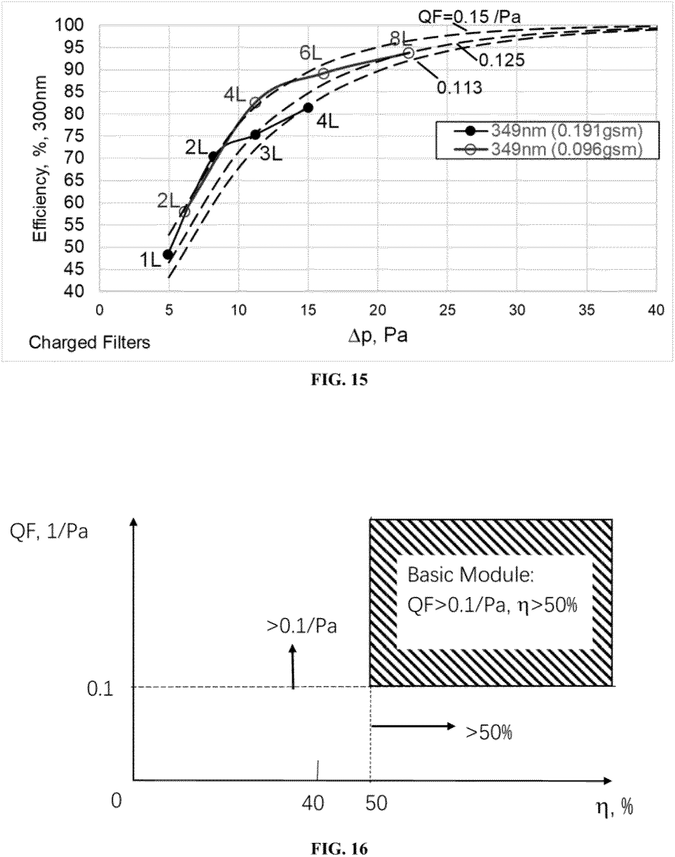

On the other hand, a small diameter nanofiber filter can also be used but the basis weight needs to be trimmed as the pressure drop can be high. FIG. 14 shows that for the 84 nm diameter, 4 modules each with a basis weight of 0.191gsm can achieve high efficiency of 96% but the pressure drop is at 39 Pa with QF below 0.1/Pa, which is undesirable. The fiber basis weight should have been reduced in the basic module. As can be seen in FIG. 14, the QF for the basic module is less than 0.1/Pa (i.e. data below the curve for constant QF=0.⅟Pa), this is again due to too much fiber basis weight for the small diamter nanofiber and it results in high pressure drop and low QF. The fiber basis weight for the basic module could have been trimmed down. An example along this point is shown in FIG. 15.

Two filters with a fiber diameter of 349 nm and fiber basis weight of 0.191gsm or 0.096gsm are compared in FIG. 15. The configuration with 8 module layers each with 0.096gsm can achieve an efficiency of 93.7% with a pressure drop of 22.2 Pa and QF=0.125/Pa. Meanwhile, the 4 module layers each with 0.191gsm can achieve an efficiency of 81.3% with a pressure drop of 15 Pa and QF=0.113/Pa. The basic module with fiber basis weight of 0.191gsm has efficiency of only 48.3% despite the pressure drop is 4.9 Pa. The efficiency does not meet the preferred minimum of 50%. By trimming the fiber basis weight or basis weight by half, the electrical interference is being reduced among neighboring charged fibers and the efficincy is increased. Note the basis module for 2×0.096 gsm has efficiency of 57.9% and pressure drop of 6.1 Pa and QF=0.14/Pa. It meets the minimum of 0.1/Pa and preferred minimum efficiency of 50%.

Now refer to FIG. 16, for a given fiber diameter the basis weight or fiber packing should be chosen such that basic module has preferred minimum efficiency of 50% and with QF minimum of 0.1/Pa. If the efficiency of the basic module is too low, a large number of module layers are required to be stack-up in order to reach a decent efficiency before the filter is loaded with aerosols. On the other hand, if the efficiency is too high, skin layer leading to cake formation in each module layer may result which leads to a filter with non-uniform aerosol distribution and unused filter area. Also, it is undesirable to have low QF due to too much fibers installed in a single module resulting in high pressure drop during depth filtration stage. Consequently, the basis weight or fiber packing of the basic module is optimized for a given fiber diameter along FIG. 16 to provide a high performance filter.

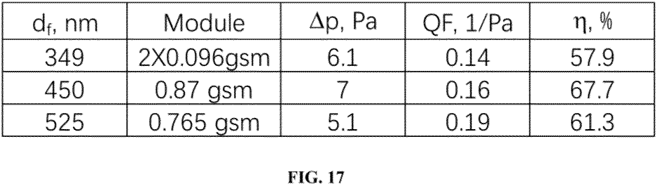

Now refer to FIG. 17, it summarizes the three basic modules of both small and large fiber diamter that satisfy the requirment of FIG. 16 with basic module with modest efficiency greater than 50% (but not too large efficiency) and QF greater than 0.1/Pa.

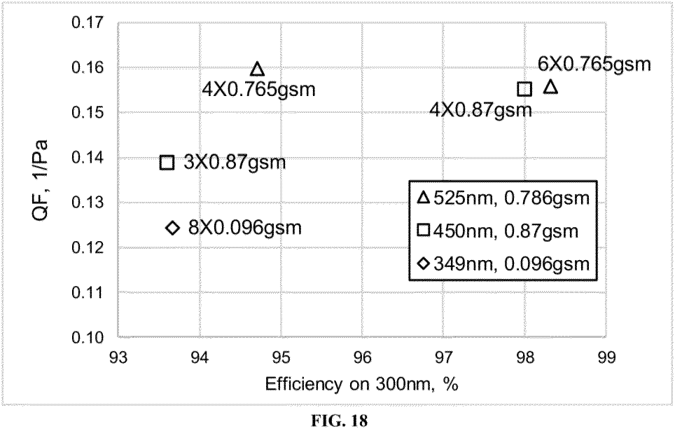

Now refer to FIG. 18, it can be seen that the 8×0.096gsm 349 nm filter is comparable in performance as compared to the 4×0.765gsm 525 nm filter and the 3×0.87gsm 450 nm filter. Therefore, the high filtration filter 100 of the present disclosure may be configured to use large diameter nanofiber or small diameter nanofiber, and achieves at least 90% efficiency prior to aerosol loading. Further, the pressure drop is sufficiently low such that the QF can be greater than 0.125/Pa and much higher than the minimum threshold of 0.1/Pa.

For using a large diameter nanofiber, such as 525 nm, a satisfactory result is obtained by arranging the filter with 4 module layers and 6 module layers, each with a fiber basis weight of 0.765gsm. Similarly, with 450 nm diameter nanofiber, the filter with 3 module layers and 3 module layers, each with a fiber basis weight of 0.87gsm can give a satisfactory result.

For using a small diameter nanofiber, such as 349 nm, the filter with 8 module layers each with a fiber basis weight of 0.096gsm can satisfy the foregoing criteria of 90% efficiency and >0.125/Pa for the QF.

The foregoing examples are selected to demonstrate the performance of the high filtration filter using large diameter nanofiber or small diameter nanofiber, which shall not be considered to be limited to such particular conditions. Instead, the examples show that the selection of the fiber diameter and fiber basis weight for loading aerosols is very important. For module layer using a large diameter nanofiber, the fiber basis weight should be large to increase the efficiency as the pressure drop is low such that the QF is above 0.125/Pa and preferably about 0.15/Pa. For module layer using small diameter nanofiber, the fiber basis weight should be small to reduce pressure drop and more module layers can be used to increase the efficiency, such that QF can be above 0.1/Pa and preferably about 0.15/Pa. Specifically, For a large average fiber diameter of 350 nm to 650 nm, a higher fiber basis weight of 0.4gsm to 0.99gsm is used for the module layer of the multi-module filter to provide sufficiently high efficiency but with low pressure drop. For small average fiber diameter 50 nm to 350 nm, a lower fiber basis weight of 0.05gsm to 0.3gsm is used for the module layer of the multi-module filter to provide sufficiently high efficiency but with low pressure drop. In all cases, it is preferable to have the quality factor QF of the filter at least 0.125/Pa and with efficiency at least 90% in a clean state prior to aerosol loading. In any case, QF should be no less than 0.1/Pa.

This illustrates the fundamental structure of a high filtration filter in accordance with the present disclosure. It will be apparent that variants of the above-disclosed and other features and functions, or alternatives thereof, may be combined into many other different methods or apparatuses. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A high filtration filter for filtering aerosols with low pressure drop across the filter and reduced cake formation when the aerosols penetrate through from an upstream side to a downstream side, the filter comprising:
a plurality of module layers, wherein an individual module layer is an electrostatically-charged polyvinylidene fluoride (PVDF) nanofiber mat; and
a plurality of separators, wherein:
the electrostatically-charged PVDF nanofiber mat with charged nanofibers is configured to better capture aerosols:
the plurality of module layers and the plurality of separators are alternatingly stacked and connected to one another; and
each of the individual module layers has a fiber basis weight depending on fiber diameter, thereby the aerosols are captured by the charged nanofibers and distributed uniformly across an entire width of the filter from the upstream side to the downstream side, and the fiber basis weight minimizes the formation of a cake layer on the upstream side of each individual module layer in the filter.

2. The filter of claim 1, wherein the individual module layer has an efficiency of greater than 50% and a quality factor of greater than 0.1/Pa.

3. The filter of claim 2, wherein the fiber basis weight for a particular fiber diameter is selected to achieve the efficiency of greater than 50% and the quality factor of greater than 0.1/Pa.

4. The filter of claim 1, wherein the charged nanofibers have antimicrobials integrated for disinfecting the aerosols captured to achieve effective disinfection.

5. The filter of claim 4, wherein the antimicrobials are metallic oxides, natural disinfection materials and chemical disinfection agents.

6. The filter of claim 5, wherein the antimicrobials are selected from a group consisting AgO, ZnO, CuO, TiO2, SnO2, Al2O3, Fe3O4, chitosan, chlorides, peroxycarboxylic acids and inorganic peroxo acids, formaldehyde, glutaraldehyde, ortho-phthalaldehyde, or any combinations thereof.

7. The filter of claim 5, wherein the antimicrobials are in a form of nanoparticles with a size in a range between 0.1 times to 1 time of an average diameter of the charged nanofibers.

8. The filter of claim 1, wherein an individual separator comprises additional macro-pores for the separator to re-orient an airflow of the aerosols through the plurality of module layers from the upstream side to the downstream side.

9. The filter of claim 1, wherein an individual separator is anti-static and has good adhesion with the plurality of module layers.

10. The filter of claim 1, wherein:
the charged nanofiber is a large diameter nanofiber having a fiber diameter in a range between 350 nm to 650 nm; and
the individual module layer has a large fiber basis weight in a range between 0.4gsm to 0.99gsm, thereby a quality factor not less than 0.1/Pa and an efficiency of not less than 90% can be maintained.

11. The filter of claim 1, wherein:
the charged nanofiber is a small diameter nanofiber having a fiber diameter in a range between 50 nm to 350 nm; and
the individual module layer has a small fiber basis weight in a range between 0.05gsm to 0.3gsm, thereby a quality factor not less than 0.1/Pa and an efficiency of not less than 90% can be maintained.

12. The filter of claim 1, wherein the filter is configured to trap a majority of the aerosols inside the filter during depth filtration and a small portion of the aerosols forms the cake layer during cake filtration.

13. A high filtration filter for filtering aerosols with low pressure drop across the filter and reduced cake formation when the aerosols penetrate through from an upstream side to a downstream side, the filter comprising:
a plurality of module layers comprising an incipient module layer and one or more subsequent module layers, wherein an individual module layer is an electrostatically-charged polyvinylidene fluoride (PVDF) nanofiber mat; and
a plurality of separators, wherein:
the electrostatically-charged PVDF nanofiber mat with charged nanofibers is configured to better capture aerosols;
the plurality of module layers and the plurality of separators are alternatingly stacked and connected to one another; and
the incipient module layer has a low fiber basis weight, thereby the aerosols are captured by the charged nanofibers and distributed uniformly across an entire width of the filter from the upstream side to the downstream side, and the fiber basis weight minimizes the formation of a cake layer on the upstream side of each individual module layer in the filter.

14. The filter of claim 13, wherein the charged nanofibers have antimicrobials integrated for disinfecting the aerosols captured to achieve effective disinfection.

15. The filter of claim 14, wherein the antimicrobials are metallic oxides, natural disinfection materials, or chemical disinfectants.

16. The filter of claim 15, wherein the antimicrobials are selected from a group consisting AgO, ZnO, CuO, TiO2, SnO2, Al2O3, Fe3O4, chitosan, chlorides, peroxycarboxylic acids and inorganic peroxo acids, formaldehyde, glutaraldehyde, ortho-phthalaldehyde, or any combinations thereof.

17. The filter of claim 15, wherein the antimicrobials are in a form of nanoparticles with a size in a range between 0.1 times to 1 time of an average diameter of the charged nanofibers.

18. The filter of claim 11, wherein:
the charged nanofiber is a large diameter nanofiber having a fiber diameter in a range between 350 nm to 650 nm; and
the individual module layer has a large fiber basis weight in a range between 0.4gsm to 0.99gsm, thereby a quality factor not less than 0.1/Pa and an efficiency of not less than 90% can be maintained.

19. The filter of claim 11, wherein:
the charged nanofiber is a small diameter nanofiber having a fiber diameter in a range between 50 nm to 350 nm; and
the individual module layer has a small fiber basis weight in a range between 0.05gsm to 0.3gsm, thereby a quality factor not less than 0.1/Pa and an efficiency of not less than 90% can be maintained.

20. The filter of claim 19, wherein the incipient module layer has different properties than the one or more subsequent module layers, wherein the properties may vary by the basis weight, fiber diameter, or fiber thickness.
